(19) United States
(12) Patent Application Publication
(10) Pub. No.: US 2005/0155914 A1
(43) Pub. Date: Jul. 21, 2005

(54) Concrete coloring tool

(76) Inventor: Brian L. Bettencourt, Modesto, CA (US)

Correspondence Address: Richard C. Litman;LITMAN LAW OFFICES, LTD., P.O. Box 15035, Arlington, VA, 22215, US

(21) Appl. No.: 10/759,136

(22) Filed: Jan. 20, 2004

(51) Int. Cl. B07B 1/49

(52) U.S. Cl. 209/418; 209/419

(57) ABSTRACT

The concrete coloring tool is a lightweight, powder application device including a handle attached to the outside of a frame with raised edges completely enclosing a perforated metallic base to be used for evenly distributing powder over newly finished concrete. The frame may be square-shaped and the handle may be attached to the frame using a T-bracket. The T-bracket allows the angle of the handle relative to the frame to be easily adjusted to compensate for the height of the user or for the elevation of the application surface.

### BACKGROUND OF THE INVENTION

1. Field of the Invention

The present invention relates to concrete and masonry tools, and particularly to a concrete coloring tool in the form of a sifting device designed specifically to be used to quickly, evenly, and easily spread color powder over newly finished concrete.

2. Description of the Related Art

The default gray color of concrete is no longer the standard in concrete paving and construction. Today vibrant colors are used to increase the aesthetic appeal of the concrete and improve the image of the construction. One method of coloring the concrete involves, among other steps, applying a colored powder over newly finished concrete. In this step when applying the powder, it is customary to employ what is known as the “dry-shake method.” The dry shake method is a hand technique used to attempt to evenly distribute the correct amount of powder over the desired surface area. The dry-shake method is well known in the art, and with practice professionals can become quite proficient at it; however, the method has several drawbacks.

The ability to spread the proper amount of powder evenly by hand is an acquired skill that poses significant difficulty to master. Often, if one has not practiced enough, amateur mistakes will be made that are undetectable until it is too late to correct them. For example, if the powder is spread too thickly in certain areas, the concrete will become too dried out and cracking may result during later stages of the process or during the life of the concrete.

The dry-shake method is also taxing on the back and arms of the worker and creates a large cloud of powder dust, often coloring the bodies of the workers applying the powder. Aside from the physical discomfort from repetitive motions in hunch-backed positions, the dust cloud creates a health risk due to potential dust inhalation.

In addition, the dry-shake method is time-consuming when applying powder to large areas. It is also often inefficient in terms of the amount of powder used properly, as compared to the amount of powder wasted in the air. A device that addresses these problems is needed, but currently there are no devices designed for such a purpose. It is widely accepted that the dry-shake method has been the customary means of application for years and is still so to this day.

There are some patents in other fields that bear some resemblance to the current invention, but none embraces all of the features of the current invention and none were designed for the purpose of replacing the dry-shake method in applying color powder to concrete.

U.S. Pat. No. 49,370, issued Aug. 15, 1865 to J. Buckland, describes a sifting shovel consisting of a small handle attached to a flat, rectangular frame enclosed around a wire netting. The device appears to be designed for use as a small, single hand, sifting shovel. U.S. Pat. No. 592,583, issued Oct. 26, 1897 to C. Eads, describes a screen scoop shovel resembling a conventional dustpan. The screen scoop shovel is constructed with an extended handle attached to a rounded raised frame with a flat open end and a screen base. The shovel is designed for the purpose of removing gravel and foreign matter from the lime used in making mortar.

U.S. Pat. No. 1,094,161, issued Apr. 21, 1914 to C. Mueller, discloses a screen shovel consisting of a shovel device with raised edges on three sides of the blade. The base of the blade is constructed of a wire mesh screen that extends partially up the three raised sides of the blade. The device is designed for the purpose of removing hot coals from ashes. U.S. Pat. No. 1,646,787, issued Oct. 25, 1927 to W. Elmenthaler, describes a sifting device constructed by enclosing a wire mesh with a frame on three sides and attaching a handle to the backside of the frame. Various methods of securing the wire mesh to the frame are disclosed.

U.S. Pat. No. 4,491,357, issued Jan. 1, 1985 to G. Richards, discloses an ash-separating shovel with raised edges on the two non-parallel sides of a trapezoid-shaped, wire mesh shovel blade. U.S. Pat. No. 5,848,697, issued Dec. 15, 1998 to L. Eash, describes a shovel-like sifter with the shovel “blade” being made entirely of a curved wire-mesh material and devoid of any frame.

Other patents showing similar sifting devises include U.S. Pat. No. 93,336, issued Aug. 3, 1869 to H. Palmer (coal scoop shovel with blade constructed of perforated metal); U.S. Pat. No. 420,106 issued Jan. 28, 1890 to W. Rowland (wire mesh scoop shovel); U.S. Pat. No. 902,954 issued Nov. 3, 1908 to E. Felty (shovel with small, removable rectangular section in the middle of the blade that may be replaced with a wire mesh).

None of the above inventions and patents, taken either singly or in combination, is seen to describe the instant invention as claimed. Thus, a concrete coloring tool solving the aforementioned problems is desired.

### SUMMARY OF THE INVENTION

The concrete coloring tool of the present invention is a lightweight, powder application device including a handle attached to the outside of a frame with raised edges completely enclosing a perforated metallic base to be used for evenly distributing powder over newly-finished concrete. In a preferred embodiment, the frame is square-shaped, and the handle is attached to the frame using a T-bracket. The T-bracket allows the angle of the handle relative to the frame to be easily adjusted to compensate for the height of the user or for the elevation of the application surface.

The concrete coloring tool is sturdy enough to withstand constant repetitive shaking motions by its user and light enough to allow the user to control the tool with ease. The frame is preferably constructed of aluminum or aluminum alloy. The raised edges on all sides of the frame prevent the accidental application of too much powder by spilling. The size of the holes in the perforated base, as will be described below, have been determined by trial and error to be the optimal size for allowing the proper amount of powder to sift through at a controllable rate by the user.

Accordingly, it is a principal object of the invention to provide a concrete coloring tool to facilitate the spreading of powder over concrete.

It is another object of the invention to provide a concrete coloring tool that minimizes the risk of over or under application of the powder when it is applied to the concrete.

It is a further object of the invention to provide a concrete coloring toll that replaces the uncomfortable, inefficient, and time-consuming manual hand application methods with a device that allows workers to accomplish the job faster and more comfortably while making more efficient use of the powder.

Still another object of the invention is to provide a concrete coloring tool that minimizes the size of the dust cloud created when applying a coloring powder to concrete in order to lessen the risk of injury by dust inhalation to the workers.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a concrete coloring tool according to the present invention.

FIG. 2 is a top view of a concrete coloring tool according to the present invention.

FIG. 3 is a bottom view of a concrete coloring tool according to the present invention.

FIG. 4 is a fragmented, side elevation view showing the handle of a concrete coloring tool according to the present invention with an aluminum pole inserted into the handle.

FIG. 5 is a fragmented, elevation view showing the handle and T-bracket of a concrete coloring tool according to the present invention.

Similar reference characters denote corresponding features consistently throughout the attached drawings.

### DETAILED DESCRIPTION OF THE PREFERRED EMBODIMENT

The present invention is a concrete coloring tool, designated generally as 10 in the drawings. The concrete coloring tool 10 is designed to gradually distribute powder over concrete as the user applies a back and forth motion to the tool while either backing up over unpowdered areas of the concrete or walking around the border of the concrete in order to be sure not to walk on the recently powdered areas.

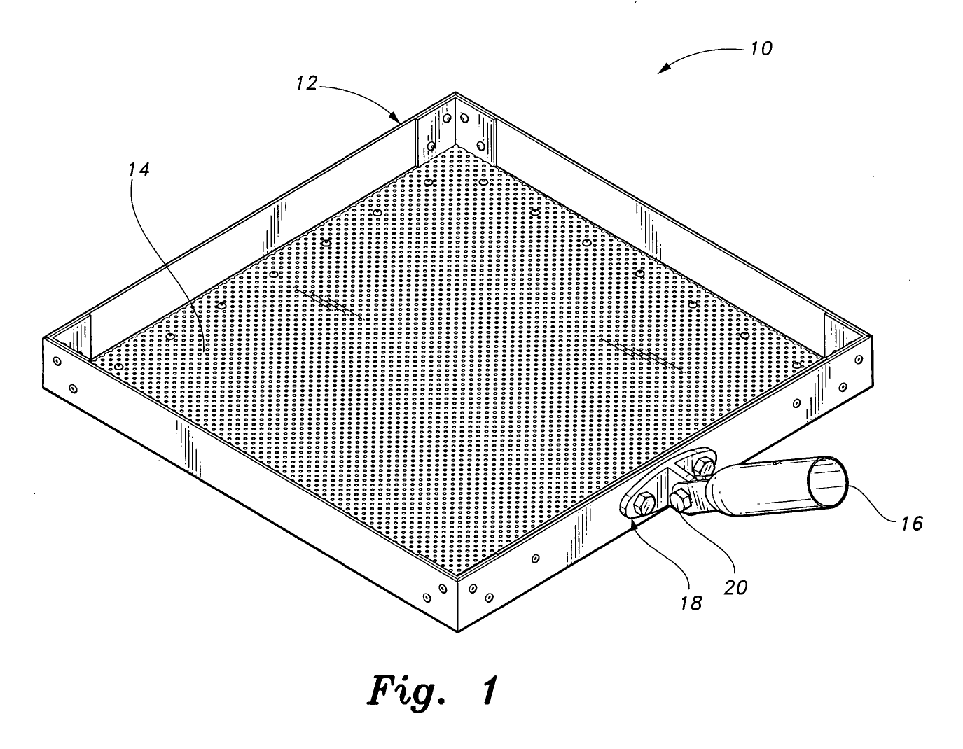

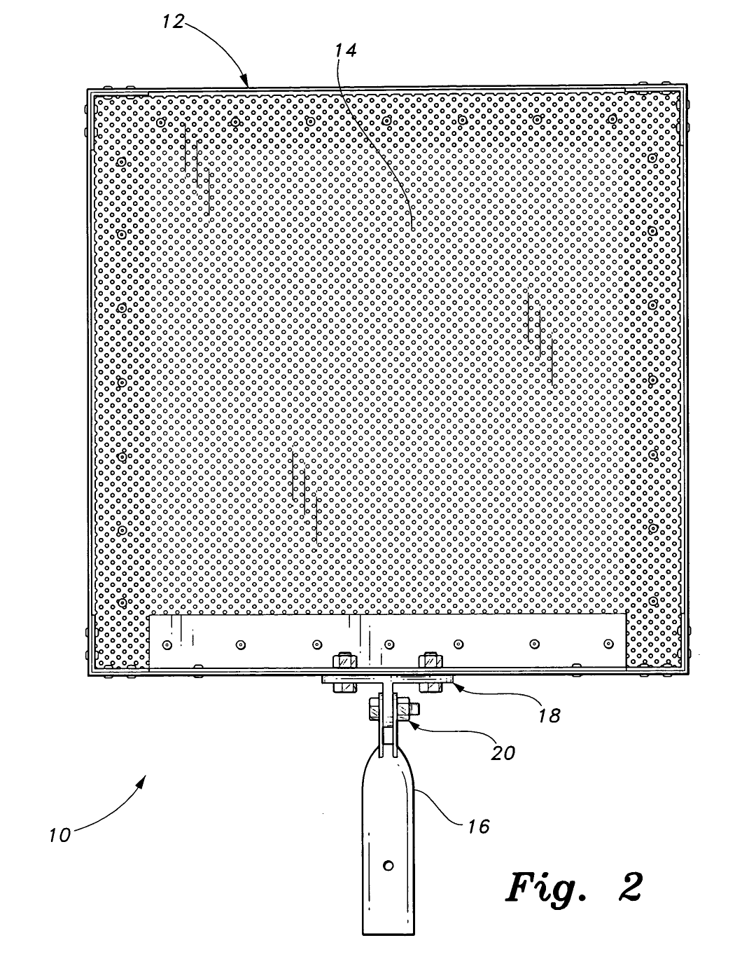

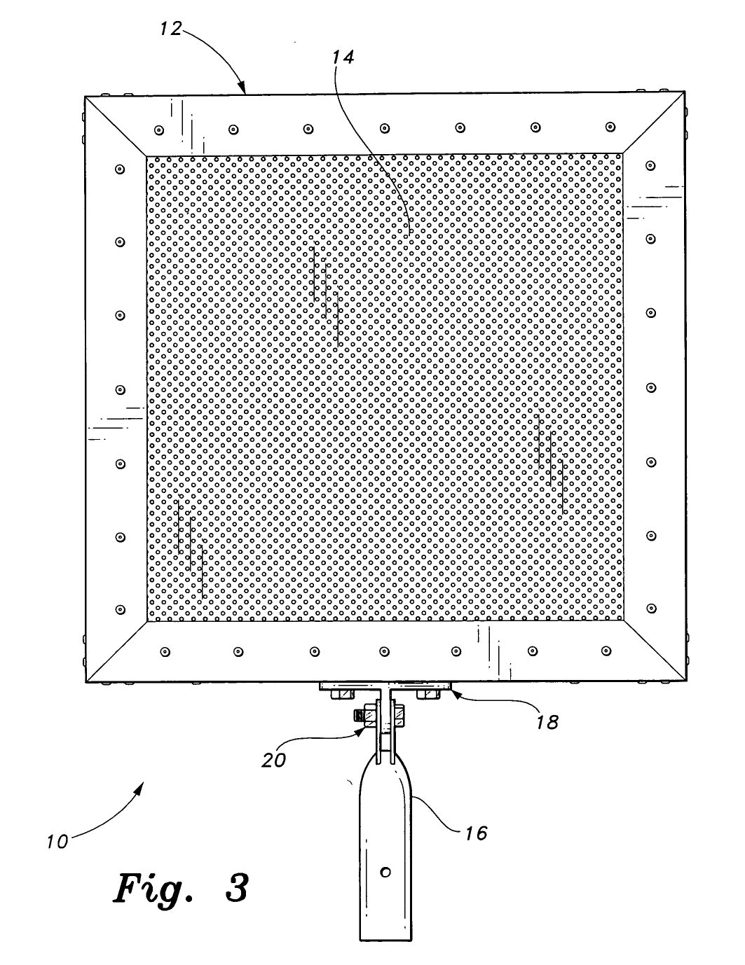

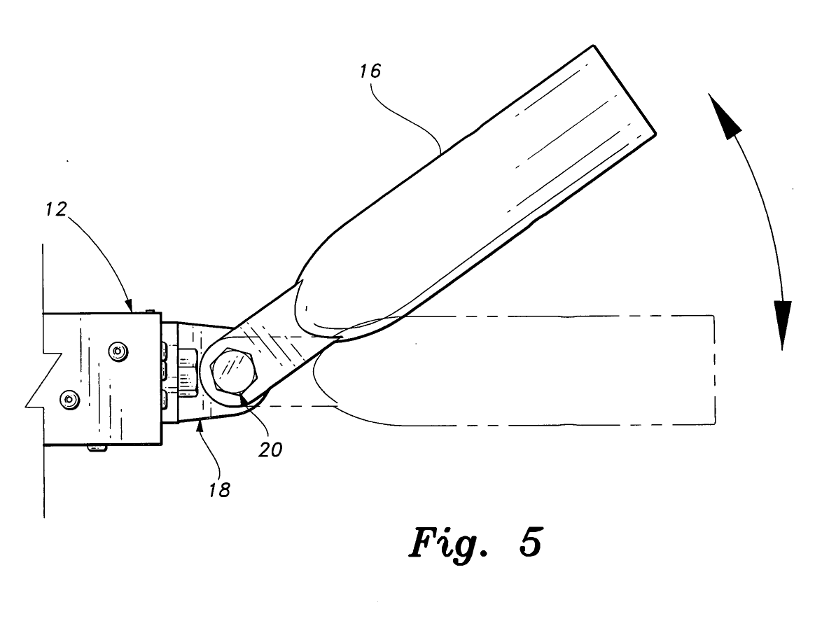

Referring first to FIG. 1, the concrete coloring tool 10 includes a handle 16 attached to the outside edge of a frame 12 having raised edges completely enclosing a perforated metal base 14. Any of various forms of attachment may be employed to secure the handle 16 to the frame 12. The preferred means, as shown in FIGS. 1-5, is a T-bracket 18, which is conventionally available. The benefit of using a T-bracket 18 is shown in FIG. 5. By loosening the nut and bolt 20 that secures the handle 16 to the T-bracket 18, the angle of the handle 16 relative to the frame 12 may be adjusted and then set by retightening the nut and bolt 20. This allows for easy adjustment for users of different heights, or for surfaces on an elevation higher or lower than the user's position.

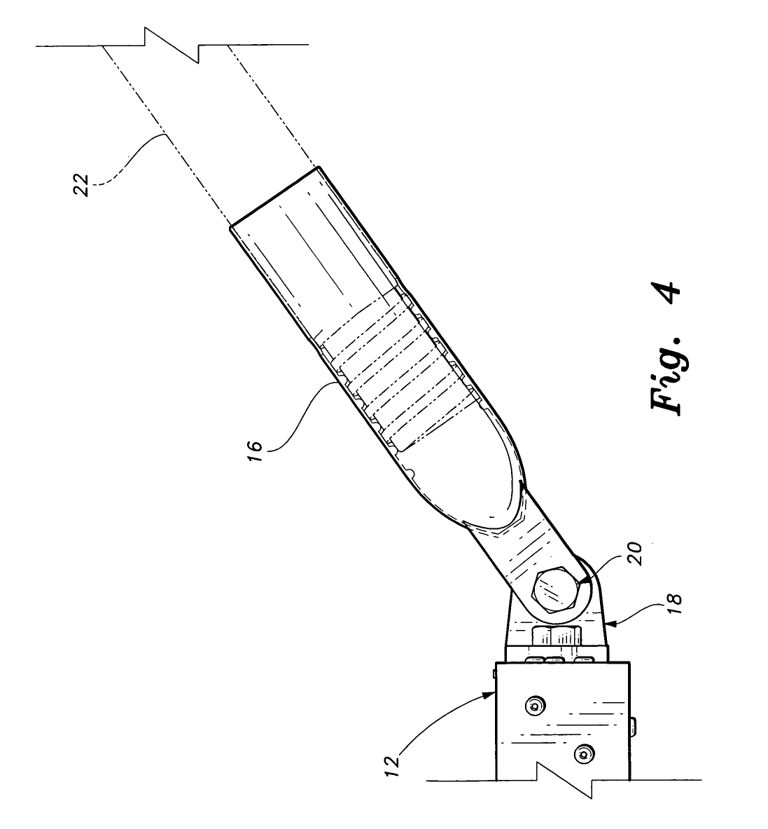

As can be seen in FIG. 1, the handle 16 is hollow. This allows the insertion of any of various types of poles 22, including, but not limited to, wood, plastic or metal to extend the length of the handle 16. The preferred embodiment uses a lightweight, aluminum pole 22, which is conventionally available. The pole 22 must be secured within the handle 16. This may be achieved in any number of ways, such as by using glue, screws or a spring-loaded detent button on the pole 22 that snaps into a detent hole on the handle 16. The preferred method, as shown in FIG. 4, is by constructing spiraling grooves within the inner side of the handle 16 into which a pole 22 may be screwed into and thereby secured.

The diameter of the holes defined in perforated base 14 is important. If the holes are too large the powder will sift out too quickly and be too difficult to control and spread evenly and at the proper depth over the concrete. If the holes are not large enough, they may prevent the silicon sand within the powder from passing through. The preferred embodiment makes use of holes with a diameter of 1/16 of an inch. It is recommended that in any embodiment the diameter of the holes be no less than 1/32 of an inch and no greater than 3/16 of an inch. The perforated base 14 should be thin and may be constructed of any of various types of sturdy materials including, but not limited to, wood, plastic or metal. The preferred material is stainless steel sheet metal, conventionally available.

The size and shape of the frame 12 is not critical. The frame 12 of the preferred embodiment is an eighteen inch square, but the size may be as small as six by six inches and of any convenient shape. It is recommended that the shape of the frame 12 be rectangular, and that the size be no smaller than six by six inches.

The frame 12 may be constructed of any of various types of sturdy materials, including, but not limited to, wood, plastic or metal. The preferred material is lightweight aluminum or aluminum alloy, conventionally available.

The preferred embodiment parts were selected to design a lightweight yet durable device with easily replaceable parts in the event of unexpected damage to any particular part. It is to be understood that the present invention is not limited to the embodiment described above, but encompasses any and all embodiments within the scope of the following claims.

1. A concrete coloring tool, comprising:
an enclosed frame having raised edges;
a flat, uniform perforated material enclosed inside of said frame; and
a handle attached to one of the edges of said frame.

2. The concrete coloring tool according to claim 1, wherein said frame is constructed of aluminum.

3. The concrete coloring tool according to claim 1, further comprising a T-bracket having a mounting plate attached to one of the edges of said frame and a socket pivotally mounted to the mounting plate, said handle being mounted in the socket, the T-bracket further having means for temporarily fixing the socket at an angular inclination to the mounting bracket in order to adjust an angular height of said handle.

4. The concrete coloring tool according to claim 1, wherein said perforated material is constructed of uniformly perforated steel sheet metal.

5. The concrete coloring tool according to claim 1, wherein:
said frame is square in shape; and
said mesh screen is constructed of uniformly perforated steel sheet metal.

6. The concrete coloring tool according to claim 1, wherein said handle is hollow.

7. The concrete coloring tool according to claim 1, further comprising an aluminum pole threaded into said handle.
